(19) United States
(12) Patent Application Publication
(10) Pub. No.: US 2011/0080120 A1
(43) Pub. Date: Apr. 7, 2011

(54) WIRELESS, REMOTELY CONTROLLED, DEVICE SELECTION SYSTEM AND METHOD

(75) Inventors: Johan Cornelis Talstra, Eindhoven (NL); Paul Jochijms, Eindhoven (NL); Lorenzo Feri, Eindhoven (NL); Hendricus Theodorus Gerardus Maria Penning De Vries, Eindhoven (NL); Johan Cornelis Talstra, Eindhoven (NL)

(73) Assignee: KONINKLIJKE PHILIPS ELECTRONICS N.V., EINDHOVEN (NL)

(21) Appl. No.: 12/994,895

(22) PCT Filed: Jun. 4, 2009
(86) PCT No.: PCT/IB09/52363

§ 371 Date: Nov. 29, 2010

(30) Foreign Application Priority Data
Jun. 11, 2008 (EP) 08158006.0

(51) Int. Cl. H05B 37/02; G08C 19/16; H02J 13/00

(52) U.S. Cl. 315/312; 340/12.22; 340/9.1

(57) ABSTRACT

The invention relates to a wireless remote controlled device selection system for selecting devices. Signal processing provides information for a remote control device. This information is indicative of the angle between the remote control device and the various devices from which a device should be selected. By comparing the angular deviations, the desired device can be selected.

### FIELD OF THE INVENTION

The invention relates to the field of selecting one or more devices out of a plurality of devices, such as lamps, by means of a wireless remote control device.

### BACKGROUND OF THE INVENTION

In current lighting systems including multiple light sources, selection and control of the light sources usually occurs by fixed devices, such as wall panels having switches. The switches are used to control the light sources such as to turn lights on or off, or dim the lights. In the event a user desires to change any lights, the user must return to the wall panel. Of course, the user needs to know which switch controls which light source. However, often the user does not have such information as switches or light sources are not marked. Such a situation is particularly problematic in the case of multiple light sources and multiple switches, where the switch that controls the desired light source is found by trial and error.

Recent developments have created remote control devices emitting a directional selection beam useful for selecting and adjusting light sources. The use of remote control devices, however, provides the risk of accidentally selecting a device (e.g. a light source) other than the desired device. This situation is particularly encountered where multiple devices are positioned closely together in relation to the distance between these devices and the remote control (i.e. the selection beam covers several devices). Therefore, a trade-off must be made between ease of selecting a device (favoring a wide selection beam from the remote control) and avoiding the risk of selecting multiple devices (favoring a narrow selection beam from the remote control).

U.S. 2003/0107888 discloses a remote-control modular lighting system utilizing a directional wireless remote control for the selective adjustment and programming of individual lighting modules. Individual lighting modules may be selected for adjustment by momentarily pointing the remote control at the lighting module to be adjusted. Subsequent adjustments may be done without aiming at the lamp, allowing the operators attention to be on the object being lit. The adjustments may include switching on/off, dimming, changing color, and aiming the light of the light source (i.e. adjustment of the light distribution). If lighting modules are spaced tightly such that multiple modules are selected by the directional selection beam, the remote control comprises an added feature enabling a user to cycle through the selected lamps by pressing a select button repeatedly, until an indicator on the desired lamp module lights.

There exists a need in the art for providing an improved system and method for selecting at least one device, such as a light source, out of a plurality of devices.

### SUMMARY OF THE INVENTION

A wireless remote controlled device selection system is proposed. The system comprises a first device comprising a first signal transmitter and a second device comprising a second signal transmitter. The system also includes a remote control device configured for wirelessly selecting at least one of the first device and the second device. The remote control device comprises a directional signal receiver configured to define a directional signal receiving pattern with a virtual reference line for receiving signals of the first signal transmitter and the second signal transmitter. In operation of the system, a first virtual line is defined for a first signal transmitted from the first signal transmitter to the directional signal receiver. Furthermore, a second virtual line is defined for a second signal transmitted from the second signal transmitter to the directional signal receiver. The first virtual line defines a first angle with the virtual reference line and the second virtual line defines a second angle with the virtual reference line. The remote control device comprises a processor configured for processing the first signal and second signal received at the directional signal receiver to obtain the first and second angle or (monotonic) derivatives thereof (e.g. signal strength). The remote control device also comprises a selector configured for selecting the first device if the first angle is smaller than the second angle and selecting the second device if the second angle is smaller than the first angle. The selection on the basis of comparing the first and second angle may involve a corresponding selection on the basis of the derivatives thereof.

Moreover, an alternative wireless remote controlled device selection system is proposed that comprises a first device having a first signal receiver and a first data transmitter and a second device having a second signal receiver and a second data transmitter. The system also contains a remote control device configured for wirelessly selecting at least one of the first device and the second device. The remote control device comprises a directional signal transmitter. The directional signal transmitter is configured to define a directional signal transmission pattern with a virtual reference line for transmitting signals to the first and second signal receiver. In operation of the system, a first virtual line is defined for a first signal transmitted from the directional signal transmitter to the first signal receiver and a second virtual line is defined for a second signal transmitted from the directional signal transmitter to the second signal receiver. The first and second signals may be first and second components of a single signal (beam) from the directional signal transmitter of the remote control device received by the first and second signal receivers, respectively. The first virtual line defines a first angle with the virtual reference line and the second virtual line defines a second angle with the virtual reference line. The first and second device each comprise a processor configured for processing the first and second signal, respectively, to obtain data indicative of the first angle and the second angle, or derivatives thereof. The remote control device comprises a data receiver configured for receiving the data indicative of the first angle and second angle (e.g. signal strength), or said derivatives thereof, from the first and second data transmitter, respectively. The remote control device also comprises a selector configured for selecting the first device if the first angle is smaller than the second angle and selecting the second device if the second angle is smaller than the first angle using the data indicative of the first and second angle. The selection on the basis of comparing the first and second angle may involve a corresponding selection on the basis of the derivatives thereof.

A remote control device and a first device, such as a lamp or luminary, for use in such systems as well as methods for operating these systems as defined in claims 21-24, respectively, are also proposed. Signals transmitted from a remote control device and from the first and second devices are preferably sufficiently different from background noise, using e.g. pseudorandom number sequences.

The gist of the invention resides in the observation that by processing the first and second signals, information can be obtained that is indicative of the angle between the remote control device and the various devices from which a device should be selected as a result of the directional signal receiver pattern and directional signal transmission pattern, respectively. The first and second signal transmitter and the first and second signal receiver, respectively, preferably have omni-directional signal patterns. By comparing the angular deviations, the desired device can be selected.

It should be appreciated that the virtual reference line may coincide with the pointing axis of the remote control device. The pattern of the directed optical receiver and the directed optical transmitter is preferably shaped symmetrical with respect to the virtual reference line. The opening angle of the pattern may be such that a user can easily select a device, e.g. in the range of 5°-40°, more preferably between 10°-30°, such as 20°.

In a practical situation, the first and second angle are obtained by measuring a derivative thereof. When the first and second signals are optical signals or radio frequency signals, the signal strength of the received first and second signals is an adequate measure of the first and second angle. The signal strength may e.g. be measured by measuring the current of a photo diode. To suppress the effect of the different signal-to-noise ratio of various photo detectors, preferably only signal strengths relative to a noise floor are processed.

The system wherein the first and second signals are emitted from the devices towards the remote control device as defined in claim 1, also referred to as a directed receiver system, is advantageous in that the information indicative of the first and second angles is readily available at the remote control device in order to select the appropriate device. Moreover, a first or second device using one or more optical receivers, such as photo detectors, is generally more expensive than a first or second device requiring optical transmitters. Furthermore, it may be easier to accommodate optical transmitters into the first and second devices, as the behavior of such transmitters is less affected by heat than for optical receivers.

The system wherein the first and second signals are emitted from the remote control device towards the devices to be selected as defined in claim 10, also referred to as a directed transmitter system, is advantageous in that such a system provides a good signal-to-noise ratio as a result of the fact that the first and second signals are already predominantly aimed at the device that the user desires to select. Moreover, such a system does not require synchronization between the first and second devices.

It should be noted that in the directed transmitter system, it not necessarily the remote control device that determines the selection. Other devices that contain a data receiver, such as another light source, may also determine the selected device. In other words, the selection decision is made externally of the remote control device and only the result is reported to the remote control device.

It should further be appreciated that the selection systems may also be used for selecting a group of at least two devices. These devices may e.g. be selected on the basis of detecting the two smallest angular deviations.

The embodiments defined in claims 2 and 11 provide for a directional signal receiver and a directional signal transmitter comprising a plurality of receiver modules and transmitter modules, respectively. These embodiments are advantageous in that the measure for the first and second angle may be made insensitive to the amplitude of the first and second signals by processing the signals for each of the plurality of receiver modules or transmitter modules. The receiver modules or transmitter modules may preferably be arranged using at least one central module surrounded by one or more satellite modules. By taking the ratio of the signal of e.g. a central module and the signal(s) of the satellite modules, the angular deviation measure is insensitive to the amplitude of the first and second signals. Consequently, a lack of calibration of the first and second signals or attenuation of the signal(s) (e.g. due to obstructions) does not harm the ability to obtain appropriate information on the first and second angle. In an embodiment using a plurality of transmitter or receiver modules within a device, calibration of these modules may be useful.

The receiver modules or transmitter modules may also be arranged in a square array, or on the corners of a triangle or a cross.

It should be appreciated that the first and second signal transmitter in a directed receiver system and the first and second signal receiver in a directed transmitter system may also comprise a plurality of transmitter modules and receiver modules, respectively.

A plurality of receiver modules may also be simulated by a single receiver as defined in claims 3 and 4. Movement of the receiver module (e.g. a photo detector or lens(es)) with respect to the first and second device may e.g. be implemented by means of piezoelectric elements. Movement may also be obtained by inherent motion of the remote control device during operation by a user, wherein the movement is recorded by means of a motion sensor (e.g. a position sensor, an inertial sensor, an accelerometer) in the remote control device. Such embodiments have also been envisaged for a directed transmitter system in order to simulate a plurality of transmitter modules in the remote control device.

The directed receiver system and the directed transmitter system preferably operate by receiving a network address of one or more devices at the remote control device in order to subsequently communicate over a direct radio link with a device using such a network address in order to provide commands to the device. For the directed receiver system, it is advantageous to convert the network address to a shorter local address for use during the selection process, as defined in claim 5, in order to improve the signal-to-noise ratio. The shorter local addresses may be assigned in an initialization step during installation of the system or be preset in a factory.

The embodiment of claim 6 provides for the use of identification codes with special cross-correlation features to reduce or eliminate interference.

The embodiment of claim 7 may be used to reduce interference between various transmitters as well.

The embodiment of claim 8 may improve the signal-to-noise ratio for the signals of those devices that are most likely to be selected.

The embodiment of claim 9 provides the advantage of using the light modules themselves of the first and second device as a transmitter of the first and second signals, thereby eliminating the need for a separate transmitter for the first and second signals. The first and second signals from the light modules may comprise unique codes in a manner described in WO2006/111930 and application EP07112787.2. The embodiment of claim 12 provides the advantage of reduced signal traffic.

The embodiment of claim 13 defines that, apart from using optical signals (such as infrared), radio frequency signals (e.g. 60 GHz) or ultrasound signals (>20 kHz) may be used for the first and second signals. Radio frequency signals have the advantage of penetrating certain materials thereby possibly improving the detection of the first and second signals. Ultrasound may enable the use of measures other than signal strength (such as phase) as an indication of the first and second angle.

The embodiment of claim 14 provides the advantage of a relatively simple handheld device and a sophisticated central controller for processing. The central controller functions as an intermediary device between the handheld device and the first and second devices.

The embodiment of claim 15 provides the advantage of preventing a spurious selection when a user sweeps the remote control device across the first and second devices without the intention of selecting them.

The embodiment of claim 16 provides the advantage of energy saving by triggering transmission of the first and second signals only upon handling the remote control device.

The embodiment of claim 17 provides the advantage of reducing the risk that the user of the remote control device selects another device upon operating the remote control device as a result of resistance or tactile feedback during operation.

The embodiment of claim 18 provides the advantage of visual feedback for the user of the remote control device to indicate the selected device(s). The visual indicator is turned on in response to a command from the remote control device that the device associated with the visual indicator has been selected. A device may have multiple visual indicators, e.g. LED's, capable of emitting light of different colors to indicate the extent to which a user is pointing at the device. A red light may e.g. indicate that the device is pointed straight on, while an orange light may indicate a deviating direction of the remote control device. A single visual indicator may also be used to signal the extent of selection, e.g. be changing the frequency of switching on and off the visual indicator.

The embodiment of claim 19 provides the advantage of using the same signal for selection of the devices and sending commands to said selected device(s), e.g. infrared signal channels or radio frequency signal channels.

The embodiment of claim 20 provides the advantage of secure key exchange for encrypting or signing subsequent data exchanged between the remote control device and the first and second devices. This is particularly true for optical signals, such as infrared signals, since such signals generally hardly leave the room of the system and are therefore difficult to intercept.

Hereinafter, embodiments of the invention will be described in further detail. It should be appreciated, however, that these embodiments may not be construed as limiting the scope of protection for the present invention.

### BRIEF DESCRIPTION OF THE DRAWINGS

In the drawings:

FIG. 1 shows a schematic illustration of a wireless remote controlled device selection system installed in a structure according to an embodiment of the invention;

FIG. 2 shows a schematic illustration of a directed receiver wireless remote controlled device selection system according to an embodiment of the invention;

FIG. 3 shows a schematic illustration of a directed transmitter wireless remote controlled device selection system according to an embodiment of the invention

FIGS. 4A and 4B show diagrammatic illustrations of the operation of the device selection system of FIGS. 2 and 3, respectively according to an embodiment of the invention;

FIG. 5 shows an example of the operation of the wireless remote controlled device selection system of FIGS. 4A and 4b using absolute signal strength;

FIG. 6 schematically shows an implementation of the device selection system of FIG. 4A;

FIG. 7 shows an example of the operation of the wireless remote control device selection system of FIG. 6;

FIG. 8 schematically shows an implementation of the device selection system of FIG. 4B;

FIGS. 9A-9D are schematic illustration of a remote control device configured for simulating a plurality of receiver modules and transmitter modules;

FIG. 10 is a schematic illustration of further components of a remote control device that may be used to advantage for a remote control device in the wireless remote controlled device system according to an embodiment of the invention;

FIGS. 11A and 11B are schematic illustrations of a first device according to an embodiment of the invention; and

FIG. 12 shows an alternative application of the wireless remote controlled device selection system.

### DETAILED DESCRIPTION OF THE DRAWINGS

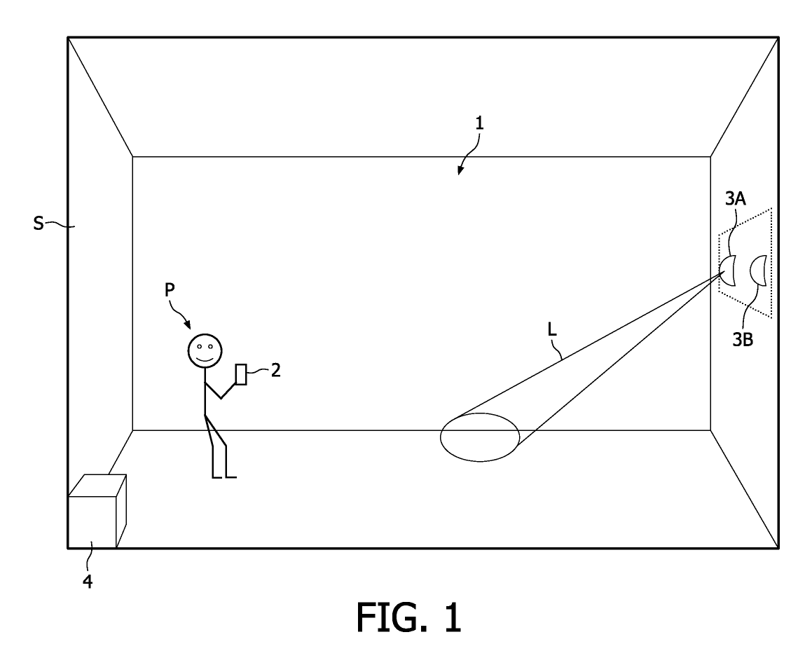

FIG. 1 is a schematic illustration of a wireless remote controlled device selection system 1 (i.e. a system wherein devices are wirelessly selected by means of a remote control device in a structure S) comprising a remote control device 2 and first and second devices 3A, 3B. First and second devices 3A, 3B are assumed to be light sources or luminaries, but may represent alternative devices, such as e.g. awnings, switches or doors.

The remote control device 2 may be a single, handheld device or a combination of a handheld device and a central controller 4.

Person P may, through the use of the remote control device 2 control the operation of the light sources 3A, 3B. The control relates e.g. to switching the light sources on/off, controlling the light intensity or the color of the light L emitted by the light sources 3A, 3B and/or controlling the direction in which the light L is emitted from the lights sources 3A, 3B.

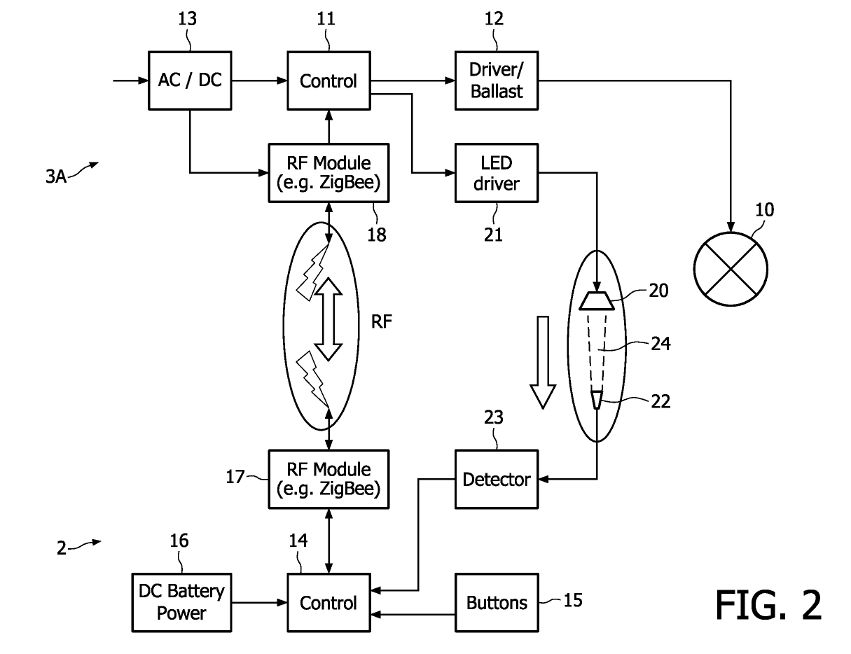

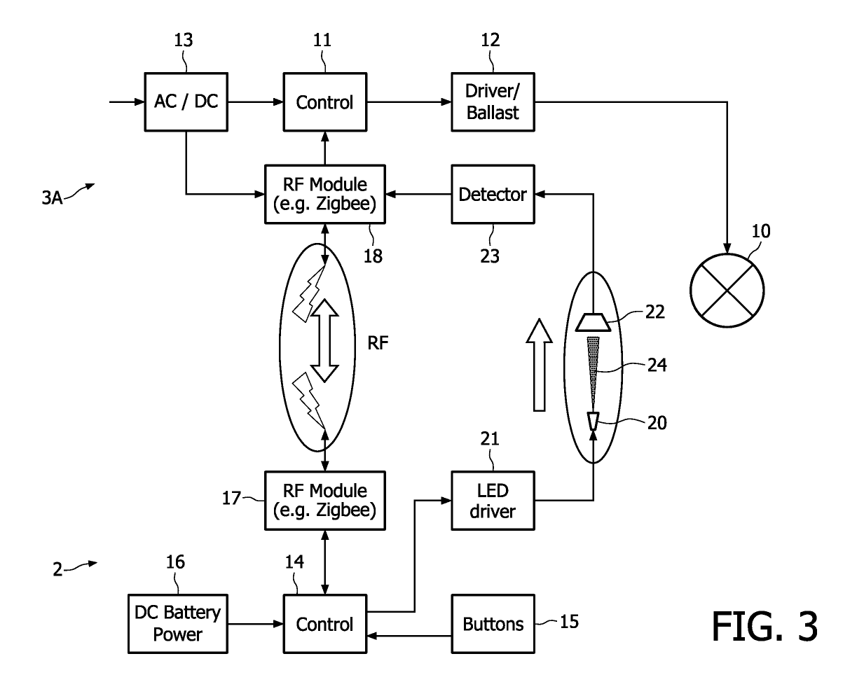

FIGS. 2 and 3 provide schematic illustrations of a directed receiver system and a directed transmitter system, respectively, for selecting and controlling a light source 3A (or 3B) using a remote control device 2.

In both systems, light source 3A comprises a light emitting element 10 controlled from a controller 11 via a driver 12 in response to a signal received from an AC/DC converter 13. Light emitting element 10 provides light L.

In both systems, remote control device 2 comprises a controller 14 configured for receiving commands from the person P operating buttons 15. Remote control device 2 also contains a battery 16.

In both systems, both the remote control device 2 and the light source 3A furthermore comprise a communication module 17, 18 enabling communication between the remote control device 2 and the light source 3A via an omni-directional radio frequency link RF. The RF link may use a predefined protocol, such as ZigBee, for transmitting information between the remote control device 2 and the light source 3A, such as control commands input by person P using buttons 15.

Providing control signals to the light sources 3A, 3B, either directly or via the central controller 4, presupposes that the light source 3A, 3B that should be controlled has been selected.

To that end, in the directed receiver system 1 of FIG. 2, light source 3A comprises a signal transmitter 20 controlled from the controller 11 and driven by a (LED) driver 21. Furthermore, remote control device 2 comprises a directional signal receiver 22 and a detector 23 for detecting signals over a directional channel 24 from the signal transmitter 20. The signals over directional channel 24 are e.g. infrared signals and are intended for selecting the light source 3A.

In contrast, in the directed transmitter system 1 of FIG. 3, remote control device 2 contains a directional signal transmitter 20 driven by a driver 21, whereas light source 3A contains a signal receiver 22 and detector 23 for detecting signals over directional channel 24 from the signal transmitter 20. Again, the signals over directional channel 24 are e.g. infrared signals and are intended for selecting the light source 3A. In the directed transmitter system, once a light source 3A detects that it has been selected, this is communicated over the radio link RF to the remote control device 2.

In both systems, selection of the light source 3A is typically performed by aiming the remote control device 2 at the light source, such that the signal of the signal transmitter 20 is detected by the detector 23. Once light source 3A is selected, a network address of light source 3A is transmitted to the remote control device 2 over radio link RF. After selection of the light source 3A, the control signals include the thus obtained network address, such that it is no longer required to aim the remote control device 2 in the direction of the light source 3A for transmitting control signals to the light source 3A over the radio link RF. This allows person P to focus attention on the position or object illuminated.

The present disclosure relates to a method for improving the accuracy of selecting a light source 3A, 3B using the remote control device 2. This aspect is especially important in a situation wherein light sources 3A and 3B are at a close distance as compared to the distance between the remote control device 2 and the light sources 3A, 3B.

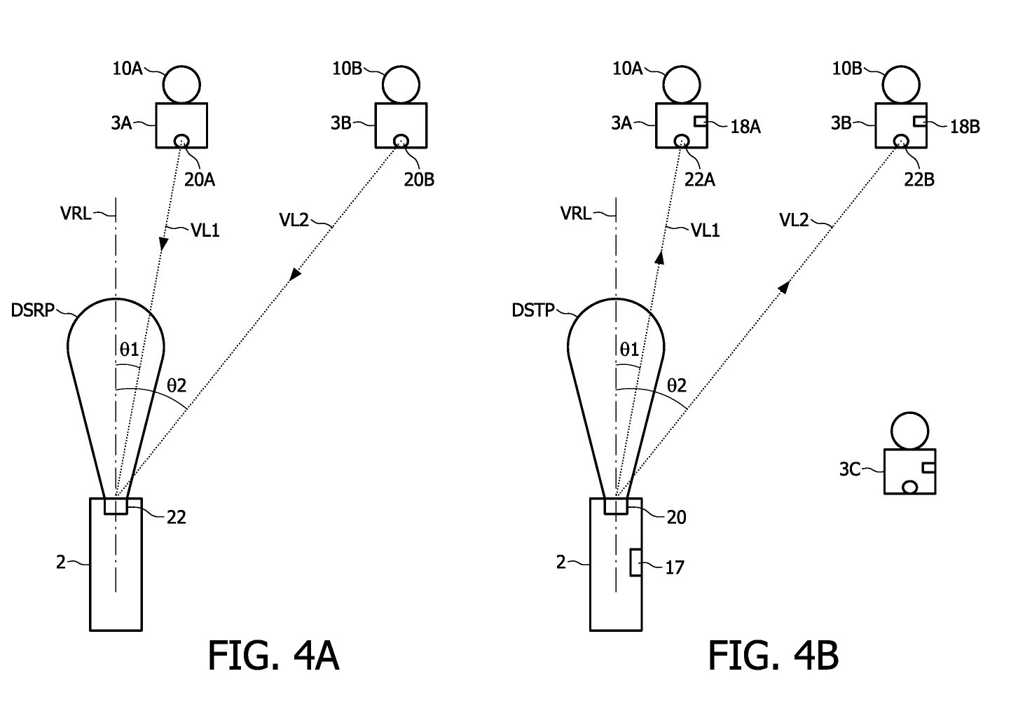

FIGS. 4A and 4B depict diagrams for the directed receiver system and directed transmitter system, respectively, illustrating the improved system and method. Generally, the improvement is obtained by processing the signals from the signal transmitter 20 in order to derive the angular deviation between the remote control device 2 and each of the light sources 3A, 3B and to select subsequently the light source with the smallest angular deviation.

FIG. 4A is a schematic diagram of a directed receiver system 1. The system comprises a first light source 3A comprising a first signal transmitter 20A and a second device 3B comprising a second signal transmitter 20B. The system also includes the remote control device 2. The remote control device 2 comprises a directional signal receiver 22 configured to define a directional signal receiving pattern DSRP with a virtual reference line VRL for receiving signals of the first signal transmitter 20A and the second signal transmitter 20B. The virtual reference line VRL coincides with the pointing axis of the remote control device 2.

In operation of the system, a first virtual line VL1 can be defined for a first signal transmitted from the first signal transmitter 20A to the directional signal receiver 22. Furthermore, a second virtual line VL2 can be defined for a second signal transmitted from the second signal transmitter 20B to the directional signal receiver 22. The first and second signal transmitters 20A, 20B are configured for omni-directional transmission of the respective first and second signals (possibly using a plurality of transmitters for each device 3A, 3B). The first virtual line VL1 defines a first angle θ1 with the virtual reference line VRL and the second virtual line VL2 defines a second angle θ2 with the virtual reference line VRL.

The first signal contains an identification code of the first light source 3A. The second signal contains an identification code of the second light source 3B. The identification codes are preferably chosen such that they are (quasi-) orthogonal with respect to each other in order to minimize interference between the first and second signals.

In some cases, it may be impractical to provide the light sources 3A, 3B with signal transmitters 20A, 20B. Instead of applying separate signal transmitters, in such cases, the light emitting elements 10A, 10B may be used for transmitting the first and second signals, possibly including identification codes.

The remote control device 2 comprises a controller 14 (see FIG. 2) having processing functionality configured for processing the first signal and second signal received at the directional signal receiver 22 to obtain the first and second angle or (monotonic) derivatives thereof. The controller 14 also comprises selection functionality for selecting the first light source 3A if the first angle θ1 is smaller than the second angle θ2 and selecting the second light source 3B if the second angle θ2 is smaller than the first angle θ1.

The selection on the basis of comparing the first and second angle may involve a corresponding selection on the basis of the derivatives thereof, such as the signal strength of the first and second signals received at the directional signal receiver 22. As an example, the selected light source 3A, 3B may be the light source from which the strongest signal is received at the directional signal receiver 22 (given the directional signal receiver pattern DSRP).

FIG. 4B is a schematic diagram of a directed transmitter system 1. The system comprises a first light source 3A having a first signal receiver 22A and a first data transmitter 18A and a second light source 3B having a second signal receiver 22B and a second data transmitter 18B. The remote control device 2 comprises a directional signal transmitter 20. The directional signal transmitter 20 is configured to define a directional signal transmission pattern DSTP with a virtual reference line VRL for transmitting a signal to the first and second signal receiver 20A, 20B. The virtual reference line VRL coincides with the pointing axis of the remote control device 2.

The remote control device 2 also comprises a data receiver 17 for receiving the data indicative of the first and second angle. It should be noted that these data may also be received by an external device, such as another light source 3C (see FIG. 4B), that makes the selection decision and reports the result to the remote control device 2 via receiver 17. Light source 3C may or may not itself have been subject of the selection process.

In operation of the system, a first virtual line VL1 can be defined for a first signal transmitted from the directional signal transmitter 20 to the first signal receiver 22A and a second virtual line VL2 can be defined for a second signal transmitted from the directional signal transmitter 20 to the second signal receiver 22B. The skilled person may appreciate that the first and second signal may originate from a single signal transmitted from the directional signal transmitter 20, wherein the first and second signal reflect the first and second component of the transmitted signal received by the first and second signal receiver 22A, 22B, respectively. The first and second signal receivers 22A, 22B are configured for omni-directional receiving of the first and second signals (possibly using a plurality of receivers for each device 3A, 3B). The first virtual line VL1 defines a first angle θ1 with the virtual reference line VRL and the second virtual line VL2 defines a second angle θ2 with the virtual reference line VRL.

The first and second light sources 3A, 3B each comprise a controller 11 (see FIG. 3) having processing functionality configured for processing the first signal and second signal, respectively, to obtain data indicative of the first angle and the second angle, or derivatives thereof (e.g. signal strength).

The remote control device 2 comprises a data receiver configured for receiving the data indicative of the first angle θ1 and second angle θ2, or said derivatives thereof, from the first and second data transmitter 18A, 18B, respectively. The remote control device 2 also comprises selection functionality configured for selecting the first light source 3A if the first angle θ1 is smaller than the second angle θ2 and selecting the second light source 3B if the second angle θ2 is smaller than the first angle θ1 using the data indicative of the first and second angle.

The selection on the basis of comparing the first and second angle may involve a corresponding selection on the basis of the derivatives thereof, such as the signal strength of the first and second signals received at the signal receivers 22A, 22B. As an example, every light source 3A, 3B informs the remote control device 2 (over the radio link RF) of the detected strength of the signal from the directional signal transmitter 20 of the remote control device 2. The remote control device 2 may then select the light sources that report the strongest signal. To suppress the effect of different signal-to-noise ratios of the first and second signal receivers, it is advantageous that only signal strength relative to a noise floor is reported.

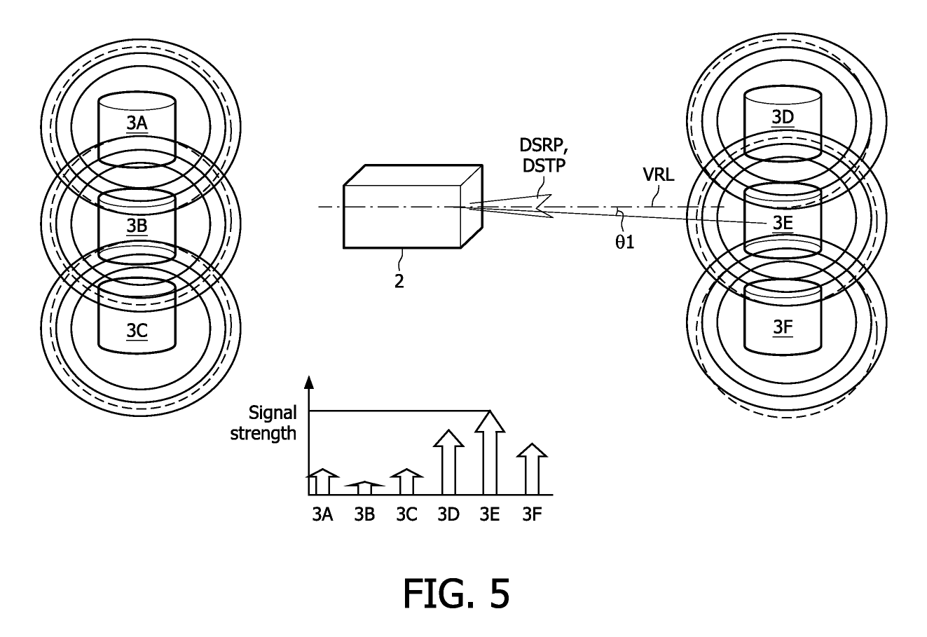

FIG. 5 provides an example, valid for the directed receiver system and for the directed transmitter system, wherein a device (in this example light source 3E) is selected on the basis of the signal strength received by the directional signal receiver 22 of FIG. 4A or the signal receivers 22A, 22B of FIG. 4B, respectively. Indeed, in this situation, the angular deviation between the virtual reference line VRL (coinciding with the pointing axis of the remote control 2) with each of the virtual lines VL (not shown) between the remote control and the light sources 3A-3F, is smallest for light source 3E.

The signal transmitter 20, 20A, 20B in the above systems 1 may use optical signals, such as infrared signals. However, radio frequency signals (e.g. 60 GHz) or ultrasound signals with a frequency of 20 kHz or higher may also be employed (of course, using suitable transmitters and receivers) as the first and second signals. Radio frequency signals have the advantage of penetrating certain materials (such as the shade of a lamp or luminary) thereby possibly improving the detection of the first and second signals. Ultrasound may enable the use of measures other than signal strength (such as phase) as an indication of the first and second angle. It should be appreciated that the same signals may be used for selection of the light sources 3A, 3B as for sending commands to said selected device(s), e.g. infrared signal channels or radio frequency signal channels.

In case infrared signals are used, these signals may also be used for exchanging security keys between the remote control device 2 and the light sources 3A, 3B over the directional channel 24. These signals hardly leave the room of the system and are therefore difficult to intercept.

In some cases, the absolute signal strength of the first and second signals, as used in the example of FIG. 5, may not be an accurate measure for the angular deviation between (the pointing axis of) the remote control device 2 and the light sources 3A, 3B. As an example, the first and/or second signals may be obstructed by shades or the signal transmitters 20A, 20B (for the directed receiver system) or the signal receivers 22A, 22B (for the directed transmitter system) may not be calibrated.

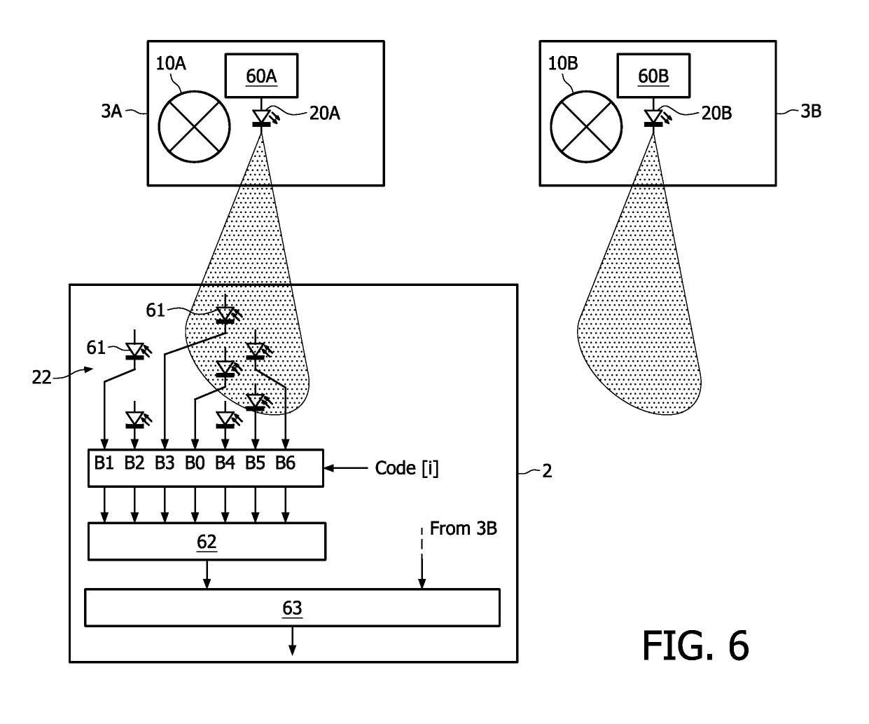

FIG. 6 provides a schematic illustration of an embodiment for (a part of) the directed receiver system 1, wherein the derivative of the first and second angle is obtained by analyzing the extent to which the remote control device 2 is pointed to a particular light source 3A and another light source 3B, and that is independent of the amplitude of the first and second signals.

The directed receiver system 1 of FIG. 6 comprises a remote control device 2 and light sources 3A, 3B.

Light sources 3A, 3B each comprise a light emitting element 10A, 10B, an identification code generator 60A, 60B and a signal transmitter 20A, 20B, represented as photo transmitter diodes, for transmitting the first and second signal, respectively. Identification code generator 60A, 60B provides (quasi-) orthogonal identification codes to be embedded in the first and second signals.

The remote control device 2 comprises a directional signal receiver 22 containing a plurality of receiver modules 61, represented as photo receiver diodes. The signals from each of the receiver modules 61 is detected separately in the detector 23 (using individual codes for each of the receiver modules). The signal strengths received by each of the receiver modules 61 are processed in order to obtain information on the extent of exposure of each of the receiver modules to the first signal (using the identification code of light source 3A) and to the second signal (using the identification code of light source 3B), respectively. The signal strengths are processed in processor 62 for the first and second signal to obtain derivatives of the first angle θ1 and the second angle θ2 to find out whether the remote control device 2 was pointed to the light source 3A transmitting the first signal or the light source 3B transmitting the second signal. In other words, it can now be determined for the first light source 3A whether the first signal hits the directional signal receiver 22 of the remote control device 2 straight on or from the side. The same can be determined for the second light source 3B. On the basis of this information, selector 63 may ultimately decide whether light source 3A or light source 3B should be selected depending on which light source emits its signal straight on the directional receiver 22 more than any other light source.

The receiver modules 61 are positioned in an arrangement configured for determining the extent to which the first and second signals are received by the receiver modules 61.

In the embodiment of FIG. 6, the arrangement of receiver modules 61 has a central receiver module BO surrounded by satellite receiver modules B1-B6.

For such an arrangement, the derivative of the first and second angles θ1, θ2 can be computed using a function ƒ(I_{central}/Iₛₐₜₑₗₗᵢₜₑₛ), wherein I_{central} and Iₛₐₜₑₗₗᵢₜₑₛ are the signal strengths (in fact the currents measured from the photo diodes in response to receiving the first and second signals) detected by the central receiver module B0 and the satellite modules B1-B6, respectively. ƒ is some monotonously increasing function of x, e.g. ƒ(x)=x/(1+x). By taking the ratio of the signal strength detected by the central receiving module B0 and the signal strength detected by the surrounding modules B1-B6, the amplitude of the first and second signals is no longer relevant. It should be appreciated that measures may be taken to avoid insensible outcomes when I_{central} and/or Iₛₐₜₑₗₗᵢₜₑₛ become zero.

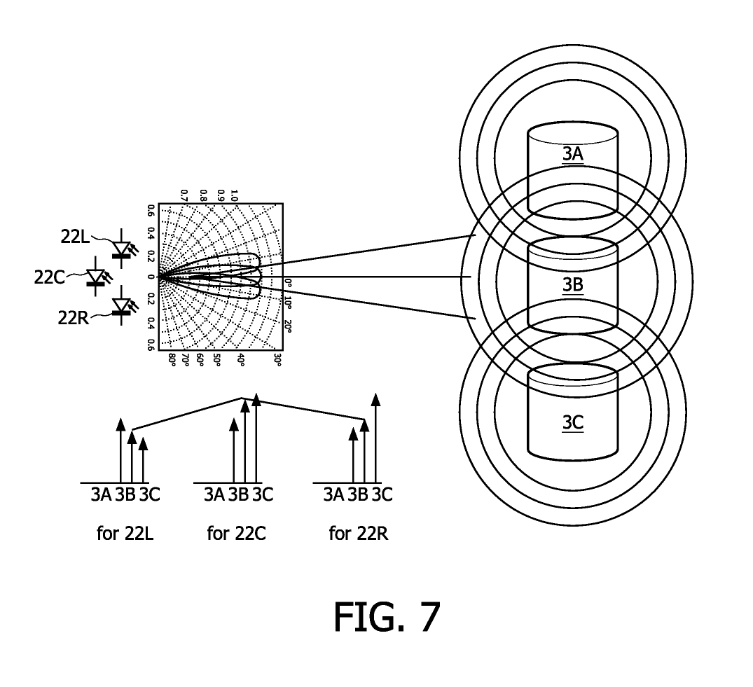

Another arrangement of receiver modules 61 may comprise a linear array of three receiving modules. The central receiving module 22C measures a current I_{central}, whereas the side receiving modules 22L, 22R measure currents I_{L} and I_{R} respectively in response to receiving the first signal and the second signal from the first, second and third signal transmitters of sources 3A, 3B and 3C. FIG. 7 shows an example of selecting the desired light source 3A, 3B, 3C using a peak detector approach for such an arrangement. An example of an analysis function ƒ may be (2I_{central}−I_{L}−I_{R})/(I_{central}+I_{L}+I_{R}) or |I_{L}−I_{R}|/(2I_{central}−I_{L}−I_{R}). In FIG. 7, light source 3B will be selected as for this light source a peak is detected corresponding to a minimal angular deviation between the remote control device 2 and the light source 3B.

Other configurations of receiver modules have been envisaged, such as a square array of photo detectors. The angular deviation for each light source may be obtained as follows. The distances of a set of detectors with a signal strength above a threshold to the centre of the array is considered. The angular deviation may then be some monotonously increasing function of the minimum distance. Yet other configurations are possible where for instance the receiver modules are located on the three vertices of an equilateral triangle or the four endpoints of the “+”-sign.

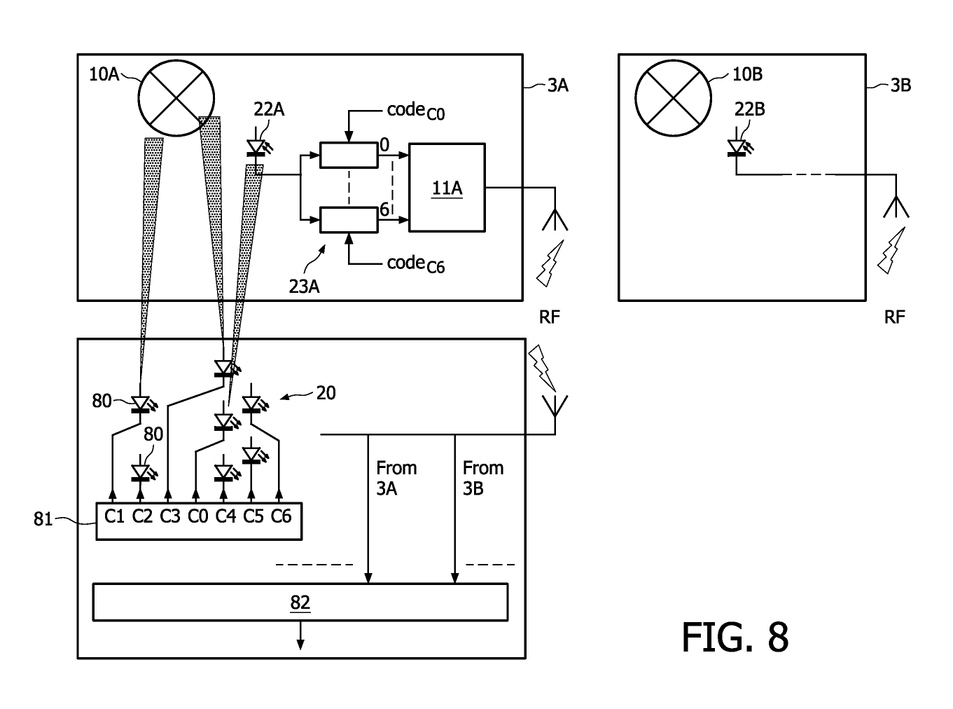

FIG. 8 provides a schematic illustration of an embodiment for (a part of) the directed transmitter system 1, wherein the derivative of the first and second angle is obtained by analyzing the extent to which the remote control device 2 is pointed to a particular light source 3A, 3B, and that is independent of the amplitude of the first and second signals.

The directed transmitter system 1 of FIG. 8 again comprises a remote control device 2 and light sources 3A, 3B.

Light source 3A comprises a light emitting element 10A, a signal receiver 22A, a code dependent detector 23A, and a controller 11A for processing the signals from the detector 23A. Light source 3A also contains a data transmitter 18A. Light source 3B comprises similar means.

The remote control device 2 comprises a directional signal transmitter 20 containing a plurality of transmitting modules 80, represented as photo transmitter diodes. The signals from each of the transmitting modules are coded using a code generator 81. Thus, the first signal as transmitted from directional signal transmitter 20 comprises a plurality of separately coded sub-signals and are detected by the first signal receiver 22A. The sub-signals are distinguished using code dependent detector 23A in order to output the signal strengths of the sub-signals received from each of the transmitting modules 80. These signals are processed using processing functionality in controller 11A in order to obtain data representative of the first angle θ1. This data is transmitted to remote control device 2 over the radio link RF by data transmitter 18A.

The same steps can be performed in light source 3B in order to obtain and transmit data representative of the second angle θ2.

The remote control device 2 then selects the desired light source 3A, 3B using selector 82 depending on which light source 3A, 3B reports a signal straight on the signal receiver 22 of the light source more than any other light source.

In the remote control device 2, the transmitter modules 80 are positioned in an arrangement configured for determining the extent to which the first and second signals are received from the transmitter modules 80.

In the embodiment of FIG. 8, the arrangement of transmitter modules 80 has a central transmitter module C0 surrounded by satellite receiver modules C1-C6.

For such an arrangement, the derivative of the first and second angles θ1, θ2 can be computed using a function ƒ (I_{central}/Iₛₐₜₑₗₗᵢₜₑₛ), wherein I_{central} and Iₛₐₜₑₗₗᵢₜₑₛ are the signal strengths of the sub-signals from the central transmitter and the satellite transmitter modules, respectively (in fact the currents measured by the photo diode 22 in response to receiving the sub-signals). ƒ is some monotonously increasing function of x, e.g. ƒ(x)=x/(1+x). By taking the ratio of the signal strength detected by the central receiving module BO and the signal strength detected by the surrounding modules B1-B6, the amplitude of the first and second signals is no longer relevant. It should be appreciated that measures may be taken to avoid insensible outcomes when I_{central} and/or Iₛₐₜₑₗₗᵢₜₑₛ become zero. Another arrangement of transmitter modules 80 may comprise a linear array of three transmitter modules. The central transmitter module transmits a sub-signal resulting in a current I_{central} in photo diode 22, whereas the side transmitting modules transmit sub-signals resulting in currents I_{L} and I_{R} in photo diode 20, respectively.

Other configurations of transmitter modules have been envisaged, such as a square array of photo transmitters. The angular deviation for each light source may be obtained as follows. The distances of a set of transmitters with a signal strength above a threshold to the centre of the array is considered. The angular deviation may then be some monotonously decreasing function of the minimum distance. Yet other configurations are possible where for instance the transmitter modules are located on the three vertices of an equilateral triangle or the four endpoints of the “+”-sign.

The plurality of receiver modules 61 (for the directed receiver system of FIG. 6) or transmitter modules 80 (for the directed transmitter system of FIG. 8) in the remote control device 2 may also be obtained by using a single receiver module or a single transmitter module and simulating a plurality of such modules.

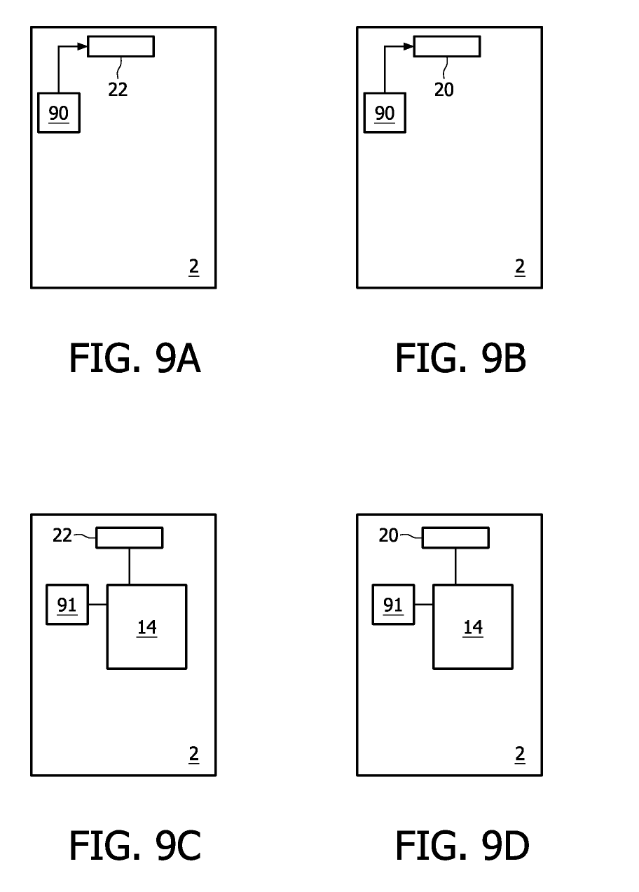

FIGS. 9A and 9B show remote control devices, wherein a single directional receiver 22 and a single directional transmitter 20 are applied in combination with a vibration module 90 (e.g. a piezo-electric element) for fast moving of the directional receiver and the directional transmitter with respect to the first and second light sources 3A, 3B. Examples of fast moving include fast moving of a photo detector and a photo transmitter or fast moving of an optical system (such as a lens) positioned in front of the photo diode or photo transmitter. The movements provide for a virtual array of photo detectors and photo transmitters, respectively. The methods as explained under reference to FIGS. 6-8 may subsequently be applied for selection of a light source 3A, 3B.

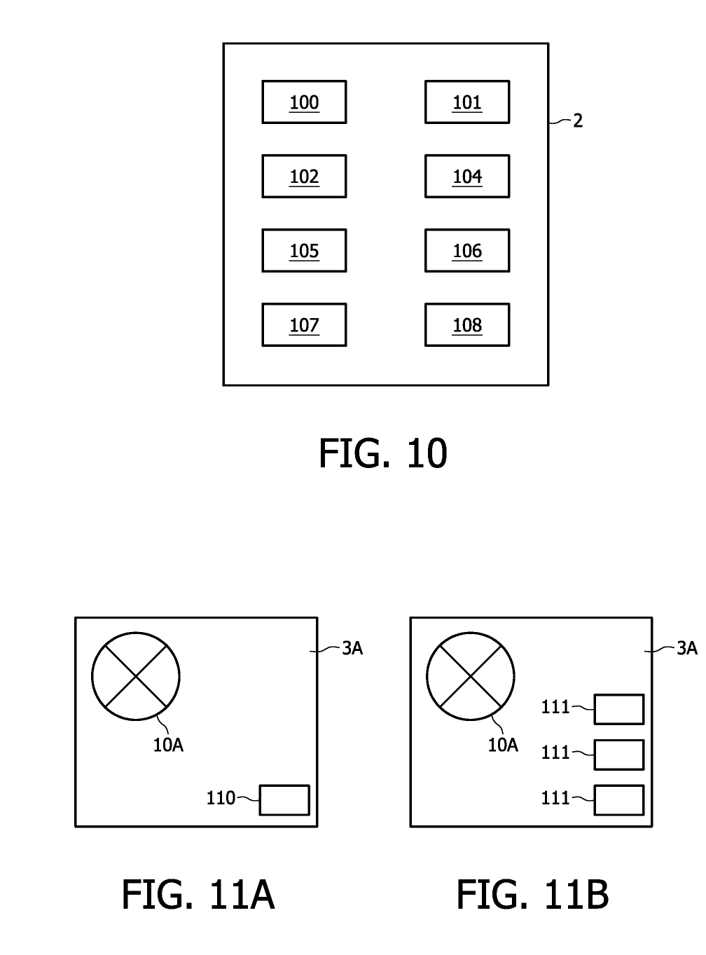

FIGS. 9C and 9D provide further embodiments of remote control devices 2, wherein a single directional receiver 22 and a single directional transmitter are illustrated respectively, whereas a plurality of such receivers or transmitters can be simulated using inherent movements of the remote control device 2 when person P uses the remote control device 2. To that end, remote control device 2 has a motion sensor 91 (e.g. an accelerometer). The controller 14 is configured to receive movement data from the motion sensor 91 in order to obtain said first angle and second angle, or said derivatives thereof. The remote control device 2 for the directed receiver system and directed transmitter system may have various other functionality that can be advantageously applied in such systems. FIG. 10 provides an overview for such a remote control device 2.

A delay module 100 may be implemented in the remote control device 2. The above-described methods of selection can be improved by delaying selection of a light source 3A, 3B by a predetermined time interval to avoid spurious selection of a light source if the remote control device 2 is swept across a light source on its way to a targeted light source. In other words, a light source is only selected if it has the smallest angle for a minimum amount of time. An appropriate time interval may be in the range of 300-1500 ms.

A motion sensor 101 and a start module 102 may be implemented in the remote control device 2 for saving energy. When person P picks up the remote control device 2, in the directed receiver system, the remote control device 2 may broadcast a command to all light sources 3 to turn on the signal transmitters 20. In the directed transmitter system, the remote control device 2 starts its directional signal transmitter 20 and broadcasts to the light sources a command to activate the signal receivers. Once a light source 3A has been detected, the signal transmitter(s) and receiver(s) may be commanded to be switched of again.

As illustrated in FIGS. 2 and 3, the remote control device 2 comprises control buttons 15. Often, if a person P points at a light source 3A, 3B, the remote control device 2 will move a little due to resistance/tactile feedback of the button, which may cause undesired selection of a light source 3A, 3B. Module 103 makes sure that a command is sent to that light source 3A, 3B which was the selected one a predetermined time interval (e.g. 100-300 ms) prior to depression of a button.

It may be advantageous to include only a subset of all light sources in the selection process in order to reduce network traffic or to improve signal-to-noise ratio. In a directed receiver system, the remote control device 2 may be configured for requesting some light sources to switch off the signal transmitter 20 on the basis of a first analysis of the signal strengths of the transmitters 20, using module 104. Similarly, in the directed transmitter system, the remote control device 2 may have an estimator 105 configured for estimating a distance to the light sources 3A, 3B using the radio link RF signal strength and to request only those light sources 3A, 3B to report the data indicative of the angle that are within a predetermined distance from the remote control device 2.

Also, for the directed receiver system, the remote control device 2 may comprise means 106 for requesting identification codes from the first and second light sources 3A, 3B, respectively, only when these light sources are within a predetermined distance from the remote control device 2. This enables a reduced length of the identification codes and decreased cross interference. This can be obtained by a low power “wake-up message” from the remote control device 2 to the light sources 3A, 3B.

For the directed receiver system, it is advantageous to convert the network address to a shorter local address for use during the selection process, in order to improve the signal-to-noise ratio. The shorter local addresses may be assigned in an initialization step during installation of the system or be preset in a factory. To that end, the remote control device may have an address assigner 107 configured for receiving network addresses of the first and second light source 3A, 3B and assigning local addresses, shorter than the network addresses, to these light sources for use in the first and second signal. A converter 108 configured for converting the local addresses to the network addresses for sending commands to said first and second device may also be implemented in the remote control device. In operation, the remote control device 2 queries the light sources 3A, 3B over the radio link RF for the network addresses. The assignor 107 then assigns shorter addresses to be used by the first and second signal transmitters 20A, 20B. The converter, using e.g. a table, of remote control device 2 converts between RF addresses and the short addresses.

FIGS. 11A and 11B are schematic illustrations of a first light source 3A according to embodiments of the invention. The first light source 3A, comprising light emitting element 10A, may either be used in the directed receiver system or in the directed transmitter system.

It may be advantageous for person P to be informed which light source has been selected using the above-described method. To that end, the light source may comprise a visual indicator 110 (FIG. 11A) or a plurality of visual indicators 111 (FIG. 11B). Multiple visual indicators may be used, e.g. using different colors, to what extent the remote control device 2 is pointed at a particular light source 3A, 3B. This functionality may also be obtained with a single visual indicator, e.g. by varying a flickering frequency of the light of the visual indicator. The visual indicators may be LED's. The visual indicators are turned on in response to a command over radio link RF from the remote control 2 that has finalized the selection process described above.

The selection methods described above may be used to select a light source 3A or another device. Multiple devices may be selected subsequently to obtain a set of selected devices to which commands can be transmitted.

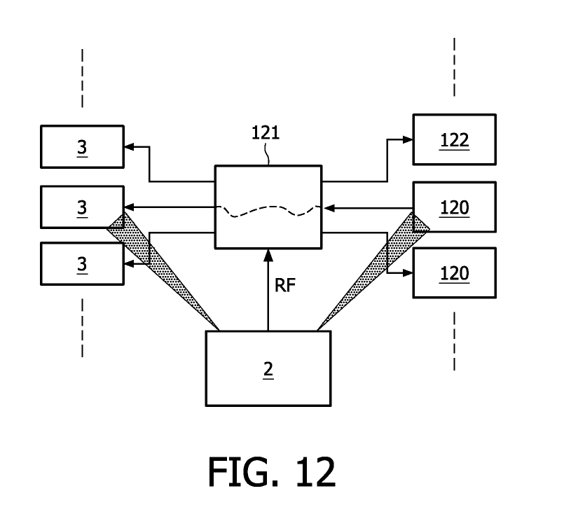

The selection methods may also be used for pairing applications, as schematically illustrated in FIG. 12.

Often a person P needs to pair multiple devices. For example, in many offices wall-switches 120 are not directly connected to lamps 3A-3C, but both lamp and switch are peripherals of a control box 121. The control box 121 must be programmed such that when a particular wall switch 120 is operated the lamp 3 in that room goes on/off. The programming of the control box and the wiring to it is very error-prone. Logically assigning wall-switches 121 (and motion detectors 122 etc.) to lamps 3 is often referred to as commissioning. The above selection methods can facilitate this process. The person P could put the system into commissioning mode using the remote control device 2 and then select a number of devices 3, 120 by pointing at them; the system would then perform the actual pairing over the omnidirectional channel RF. Even if the cabling is erroneous this will still assign the right switch 121 to the right lamp 3.

1. A wireless remote controlled device selection system (1) comprising:
a first device (3A) comprising a first signal transmitter (20A);
a second device (3B) comprising a second signal transmitter (20B);
a remote control device (2) configured for selecting at least one of said first device and said second device and comprising a directional signal receiver (22), said directional signal receiver being configured to define a directional signal receiving pattern (DSRP) with a virtual reference line (VRL) for receiving signals of said first signal transmitter and said second signal transmitter,
wherein, in operation of said system, a first virtual line (VL1) is defined for a first signal transmitted from said first signal transmitter to said directional signal receiver and a second virtual line (VL2) is defined for a second signal transmitted from said second signal transmitter to said directional signal receiver, said first virtual line defining a first angle (θ1) with said virtual reference line and said second virtual line defining a second angle (θ2) with said virtual reference line,
the remote control device comprising:
a processor (14) configured for processing said first signal and second signal detected at said directional signal receiver to obtain said first angle and said second angle, or derivatives thereof, and
a selector (63) configured for selecting at least said first device if said first angle is smaller than said second angle and selecting said second device if said second angle is smaller than said first angle.

2. The system (1) according to claim 1, wherein said directional signal receiver (22) comprises an arrangement of a plurality of receiver modules, each of said receiver modules being connected to a signal strength processing module (62) for processing the signal strength of said first and second signal.

3. (canceled)

4. The system (1) according to claim 1, wherein said remote control device comprises a motion sensor (91) and said processor (14) is configured to receive movement data from said motion sensor in order to obtain said first angle and second angle, or said derivatives thereof.

5. The system (1) according to claim 1, wherein said remote control device comprises:
an address assigner (107) configured for receiving network addresses of said first and second device and assigning local addresses, shorter than said network addresses, to said first and second device, said local addresses being used for said first and second signal;
a converter (108) configured for converting said local addresses to said network addresses for sending commands to said first and second device.

6. The system (1) according to claim 1, wherein said first signal transmitter (20A) and second signal transmitter (20B) are configured for providing said first signal and second signal with orthogonal or quasi-orthogonal identification codes of said first and second devices.

7. The system (1) according to claim 1, wherein said remote control device (2) comprises means for requesting identification codes of said first signal and second signal from said first and second devices, respectively, only when said devices are within a predetermined distance from said remote control device.

8. The system (1) according to claim 1, wherein said remote control device (2) is configured for commanding at least one of said first device and said second device to turn off said first signal transmitter and said second signal transmitter, respectively, if said first angle or said second angle exceed a predetermined threshold angle.

9. The system (1) according to claim 1, wherein said first device and said second device are lamp devices (20A, 20B) containing one or more light emitting elements (10A,10B) and wherein said first signal transmitter and second signal transmitter comprise one or more of said light emitting elements.

10. A wireless remote controlled device selection system (1) comprising:
a first device (20A) comprising a first signal receiver (22A) and a first data transmitter (18A)
a second device (20B) comprising a second signal receiver (22B) and a second data transmitter (18B);
a remote control device (2) configured for selecting at least one of said first device and said second device and comprising a directional signal transmitter (20), said directional signal transmitter being configured to define a directional signal transmission pattern (DSTP) with a virtual reference line (VRL) for transmitting signals to said first signal receiver and said second signal receiver,
wherein, in operation of said system, a first virtual line (VL1) is defined for a first signal transmitted from said directional signal transmitter to said first signal receiver and a second virtual line (VL2) is defined for a second signal transmitted from said directional signal transmitter to said second signal receiver, said first virtual line defining a first angle (θ1) with said virtual reference line and said second virtual line defining a second angle (θ2) with said virtual reference line,
the first and second device comprising a processor (11A;11B) configured for processing said first signal and second signal, respectively, to obtain data indicative of said first angle and said second angle, or derivatives thereof
the remote control device (2) or another device (3C) comprising:
a data receiver (configured for receiving said data indicative of said first angle and second angle, or said derivatives thereof, from said first data transmitter and said second data transmitter;
a selector (82) configured for selecting at least said first device if said first angle is smaller than said second angle and selecting said second device if said second angle is smaller than said first angle using said data indicative of said first and second angle.

11. The system (1) according to claim 10, wherein said directional signal transmitter (20) comprises an arrangement of a plurality of transmitter modules (80), such as photo transmitters, said transmitter modules being configured to transmit coded first signals and coded second signals and wherein said first signal receiver (22A) and second signal receiver (22B) are connected to signal strength processing modules (11A; 11B) for processing the signal strength for said coded first signals and coded second signals to obtain said data indicative of said first and second angle.

12. The system (1) according to claim 10, wherein said remote control device (2) is configured for estimating a distance between said remote control device and said first device and said second device and for requesting transmission of said data indicative of said first angle and second angle, or said derivatives thereof, only if said estimated distance is below a predetermined threshold distance.

13. The system (1) according to claim 1, wherein said first signal and second signal are selected from optical signals, ultrasound signals and radio frequency signals and wherein said selector is configured to select said first device or said second device after a predetermined delay time, said remote control device comprising
a motion sensor and a start module to trigger transmission of said first signal and second signal in response to detecting movement of said remote control device by said motion sensor, and/or
a command means for transmitting a command to said first device or said second device, wherein said remote control device is configured to transmit said command to the device selected by said selector by a predetermined time interval prior to operating said command means.

14. The system (1) according to claim 1, wherein said remote control device (2) comprises a handheld device and a central controller (4).

15-17. (canceled)

18. The system (1) according to claim 1, wherein said first control device and second control device comprise one or more visual indicators (110; 111) configured for signaling selection by said remote control device (2).

19. The system (1) according to claim 1, wherein said remote control device comprises a switching module for switching between a selection mode for selecting said first or second device and a command mode for transmitting commands to said selected first or second device.

20-22. (canceled)

23. A method for selecting at least one of a first device and a second device in a wireless remote controlled device selection system comprising
a first device comprising a first signal transmitter;
a second device comprising a second signal transmitter;
a remote control device configured for selecting at least one of said first device and said second device and comprising a directional signal receiver, said directional signal receiver being configured to define a directional signal receiving pattern with a virtual reference line for receiving signals of said first signal transmitter and said second signal transmitter,
wherein the remote control is aimed at the first device or the second device such that a first virtual line is defined for a first signal transmitted from said first signal transmitter to said directional signal receiver and a second virtual line is defined for a second signal transmitted from said second signal transmitter to said directional signal receiver, said first virtual line defining a first angle with said virtual reference line and said second virtual line defining a second angle with said virtual reference line, the method comprising the steps of:
processing said first signal and second signal detected at said directional signal receiver to obtain said first angle and said second angle, or derivatives thereof, and
selecting said first device if said first angle is smaller than said second angle and selecting said second device if said second angle is smaller than said first angle.

24. A method for selecting at least one of a first device and a second device in a wireless remote controlled device selection system comprising:
a first device comprising a first signal receiver and a first data transmitter;
a second device comprising a second signal receiver and a second data transmitter;
a remote control device configured for selecting at least one of said first device and said second device and comprising a directional signal transmitter, said directional signal transmitter being configured to define a directional signal transmission pattern with a virtual reference line for transmitting signals to said first signal receiver and said second signal receiver,
wherein the remote control is aimed at the first device or the second device such that a first virtual line is defined for a first signal transmitted from said directional signal transmitter to said first signal receiver and a second virtual line is defined for a second signal transmitted from said directional signal transmitter to said second signal receiver, said first virtual line defining a first angle with said virtual reference line and said second virtual line defining a second angle with said virtual reference line,
the method comprising the steps of:
processing said first signal and second signal, respectively, to obtain said first angle and said second angle, or derivatives thereof
selecting said first device if said first angle is smaller than said second angle and selecting said second device if said second angle is smaller than said first angle.

25. The system according to claim 1, wherein said directional signal receiver comprises a single receiver module and wherein said receiver module, or a part thereof, is configured for changing position with respect to said first and second device.
